(19) United States
(12) Patent Application Publication
(10) Pub. No.: US 2025/0133463 A1
(43) Pub. Date: Apr. 24, 2025

(54) PUBLIC LAND MOBILE NETWORK SELECTION WHEN ROUTE INFORMATION IS AVAILABLE

(71) Applicant: QUALCOMM Incorporated, San Diego, CA (US)

(72) Inventors: Sohrab AHMAD, Hyderabad (IN); Raghuveer Ramakrishna Srinivas TARIMALA, Hyderabad (IN); Bhanu Kiran JANGA, Hyderabad (IN); Rishika TINDOLA, Hyderabad (IN); Abhishek BHATNAGAR, San Diego, CA (US); Arvind Vardarajan SANTHANAM, San Diego, CA (US); Osama LOTFALLAH, San Diego, CA (US); Abhijeet PRASAD, San Diego, CA (US); Simon ISSAKOV, Wayne, PA (US)

(21) Appl. No.: 18/489,987

(22) Filed: Oct. 19, 2023

(51) Int. Cl. H04W 36/14; H04W 36/32

(52) U.S. Cl. CPC H04W 36/14; H04W 36/32

(57) ABSTRACT

Certain aspects of the present disclosure provide techniques for selecting a public land mobile network (PLMN) based on route information. A method that may be performed by a wireless node includes camping on a first cellular network on a first frequency band of one or more first frequency bands associated with a first mobile country code (MCC) of a planned route of the wireless node; detecting a condition with the first cellular network after the camping on the first cellular network; and searching, after detecting the condition, for service on the one or more first frequency bands and one or more second frequency bands associated with a second MCC, wherein the one or more second frequency bands are selected based on the first MCC and the planned route.

### BACKGROUND

### Field of the Disclosure

Aspects of the present disclosure relate to wireless communications, and more particularly, to techniques for selecting a public land mobile network (PLMN) based on route information.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes camping on a first cellular network on a first frequency band of one or more first frequency bands associated with a first mobile country code (MCC) of a planned route of the wireless node; detecting a condition with the first cellular network after the camping on the first cellular network; and searching, after detecting the condition, for service on the one or more first frequency bands and one or more second frequency bands associated with a second MCC, wherein the one or more second frequency bands are selected based on the first MCC and the planned route.

Another aspect provides a wireless node configured for wireless communications. The wireless node includes a memory comprising computer-executable instructions; and a processor configured to execute the computer-executable instructions and cause the wireless node to: camp on a first cellular network on a first frequency band of one or more first frequency bands associated with a first mobile country code (MCC) of a planned route of the wireless node; detect a condition with the first cellular network after the wireless node camps on the first cellular network; select one or more second frequency bands associated with a second MCC, based on the first MCC and the planned route; and search, after the wireless node detects the condition, for service on the one or more first frequency bands and the one or more second frequency bands.

Yet another aspect provides an apparatus for wireless communications. The apparatus includes means for camping on a first cellular network on a first frequency band of one or more first frequency bands associated with a first mobile country code (MCC) of a planned route of the apparatus; means for detecting a condition with the first cellular network after the camping on the first cellular network; and means for searching, after detecting the condition, for service on the one or more first frequency bands and one or more second frequency bands associated with a second MCC, wherein the one or more second frequency bands are selected based on the first MCC and the planned route.

Yet another aspect provides a non-transitory computer-readable medium comprising computer-executable instructions that, when executed by a processor of a wireless node, cause the wireless node to perform operations for wireless communications. The method includes camping on a first cellular network on a first frequency band of one or more first frequency bands associated with a first mobile country code (MCC) of a planned route of the wireless node; detecting a condition with the first cellular network after the camping on the first cellular network; and searching, after detecting the condition, for service on the one or more first frequency bands and one or more second frequency bands associated with a second MCC, wherein the one or more second frequency bands are selected based on the first MCC and the planned route.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of a planned route for a wireless device.

FIG. 6 depicts an example flow chart of operations by a user equipment (UE).

FIG. 7 depicts a call flow diagram for communications in a network between a network entity of mobile country code (MCC) A, a UE, and a network entity of MCC B.

FIG. 8 depicts a method for wireless communications.

FIG. 9 depicts aspects of an example communications device.

### DETAILED DESCRIPTION

Aspects of the present disclosure provide apparatuses, methods, processing systems, and computer-readable mediums for selecting (e.g., by a UE) a public land mobile network (PLMN) (e.g., for camping) based on route information.

Internet of Things (IoT) devices are desired to have battery lives of several years. IoT devices are frequently employed in fixed locations, e.g., for monitoring of fixed equipment, and therefore IoT devices employed in fixed locations can camp on a cellular network for extended periods without scanning frequency bands to look for service. For IoT devices like trackers (e.g., devices that enable location of shipments including the devices), mobility of the IoT devices can cause the IoT devices to scan for service as the IoT devices move to new locations. Frequency band scanning associated with PLMN selection during transit can cause significant power drain from batteries of the IoT devices.

In aspects of the present disclosure, a wireless node (e.g., a UE or an IoT device) that has a planned route searches for service based on the planned route. The planned route may be provided by an original equipment manufacturer (OEM) or other shipper when preparing a shipment including the wireless node (e.g., a tracker), for example. When the wireless node loses service (e.g., by moving out of a service area of a wireless network), the wireless node selects frequency bands to search for service based on the planned route. The planned route may include information regarding countries (e.g., mobile country codes (MCCs)) the wireless node is expected to enter and/or frequency bands on which the wireless node may expect to find service. The wireless node may search the selected frequency bands for service before and/or preferentially over searching other frequency bands for service.

When the wireless node finds service in a new country, the wireless node can then ignore and/or avoid scanning frequency bands of the previous country of the planned route. If the wireless node loses service in the new country, the wireless node can again select frequency bands to search for service based on the planned route, as described above. When the wireless node finds service in yet another new country, the wireless node can then ignore and/or avoid scanning frequency bands of the previous new country of the planned route. If the wireless node fails to find service for a long period of time (e.g., the shipment the wireless node is in is off the planned route), the wireless node can then to a full frequency band scan to find service.

A wireless node, by searching for service based on a planned route as described herein, may preferentially search frequency bands on which the wireless node is expected to find service on the planned route and avoid scanning frequency bands on which the wireless node is not expected to find service. By preferentially scanning frequency bands on which the wireless node is expected to find service, the wireless node may shorten the wireless node's camping time (i.e., the time spent to find a suitable cell and begin camping on a public land mobile network (PLMN)) and improve the user experience by shortening the time the wireless node is out of service. In addition, by avoiding unnecessarily scanning frequency bands on which the wireless node is not expected to find service, the wireless node may save power and provide a longer battery life. Network operators may also avoid unnecessary signaling on some PLMNs, because wireless nodes as described herein preferentially camp on other PLMNs (i.e., the PLMNs associated with the planned route), instead of camping on PLMNs that are not on the planned route.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

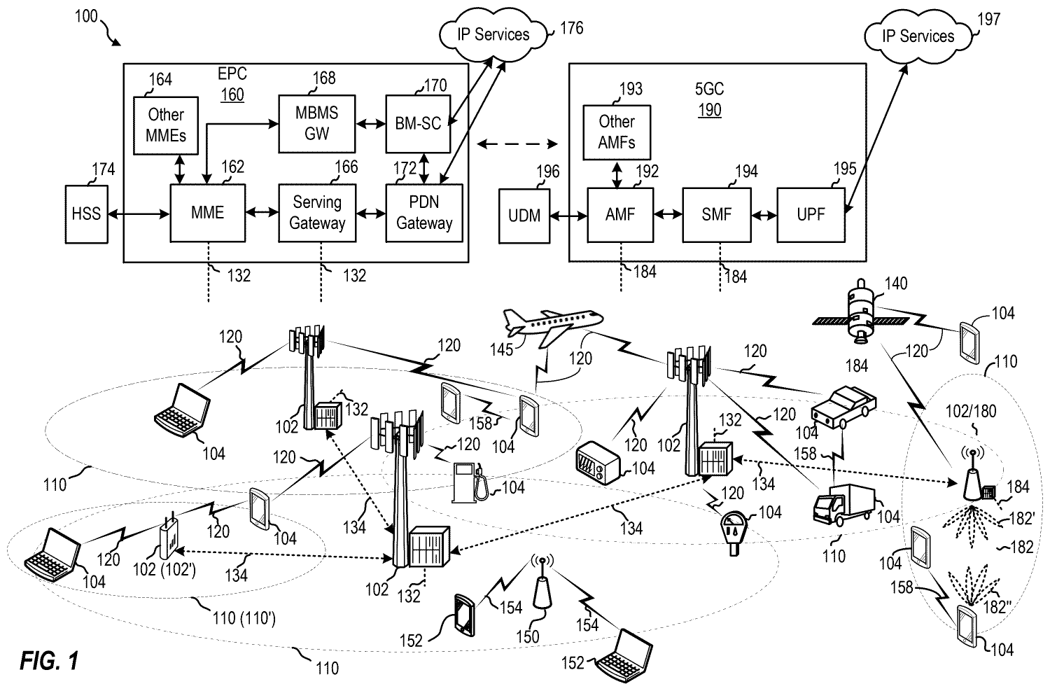

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

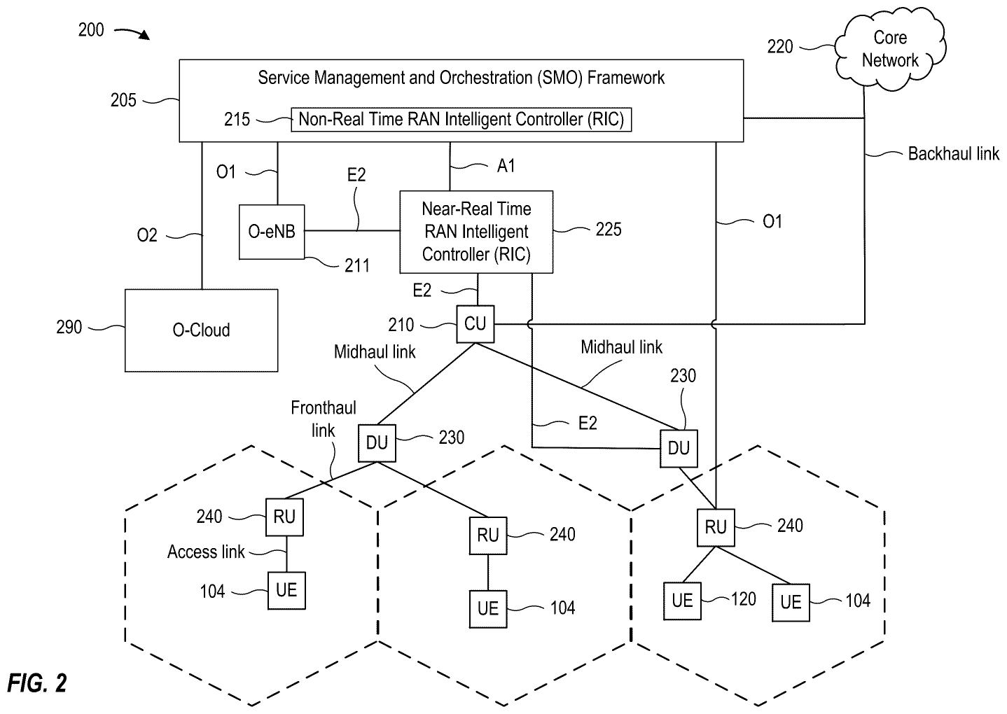

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

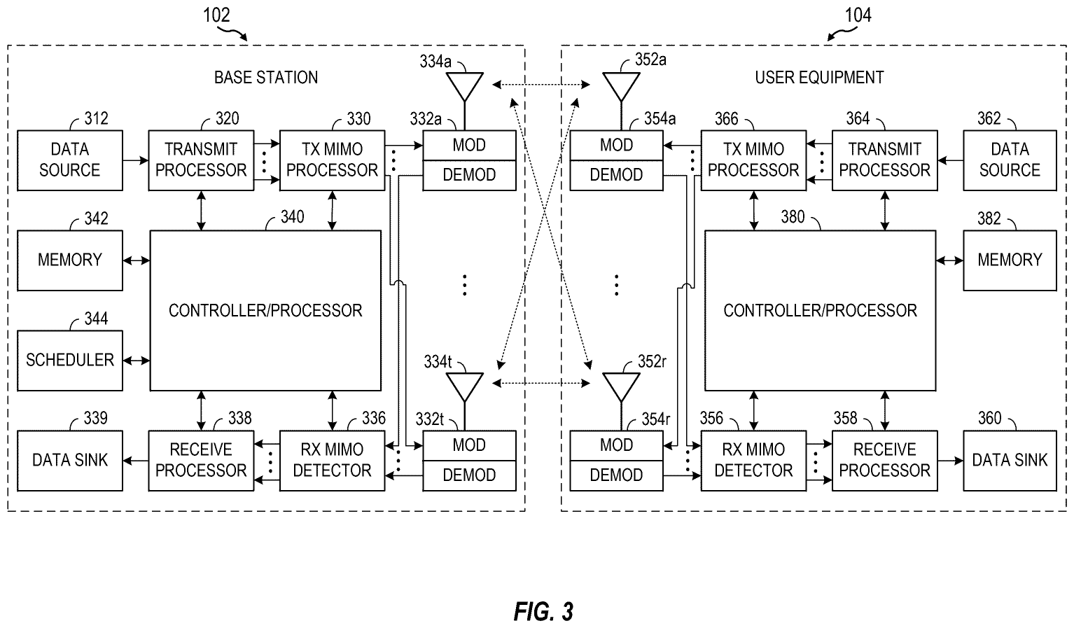

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

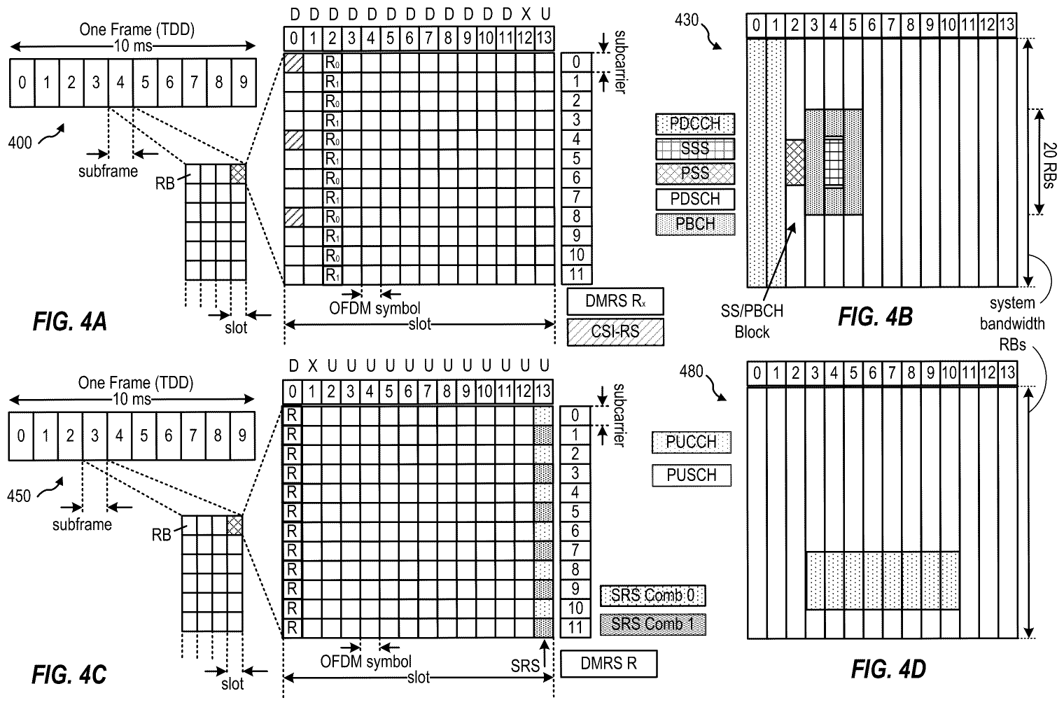

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Internet of Things (IoT) devices are desired to have battery lives of several years. For IoT devices like trackers (e.g., devices that enable location of shipments including the devices), frequency band scanning associated with PLMN selection during transit can cause undesirable power drains from batteries of the IoT devices.

It is therefore desirable to develop techniques to improve PLMN selection by IoT devices.

### Aspects Related to Selecting a Public Land Mobile Network Based on Route Information

IoT and other wireless devices, such as trackers, may follow a planned route before reaching an end point. In many cases, a route for a device is known when a shipment including the device is booked, and the shipper (e.g., a shipment company) knows the path and intermediate destinations of the shipment and the device.

In aspects of the present disclosure, information regarding the planned route can be provided to a wireless device (e.g., a modem of an IoT device), and with that information the wireless device can more efficiently scan frequencies during PLMN selection and reduce the wireless device's camping time (i.e., time spent trying to find a suitable cell for camping on) during transit.

According to aspects of the present disclosure, a wireless node (e.g., an IoT device or a UE) may camp on a first cellular network on a first frequency band associated with a first mobile country code (MCC) of a planned route of the wireless node. The wireless node, after detecting a condition with the first cellular network, searches for service on one or more second frequency bands selected based on the first MCC and the planned route. That is, the wireless node searches for service on frequency bands of MCCs on which the wireless node expects to find service, based on the planned route. The condition the wireless node detects can be, for example, being out of service (OOS) on the first cellular network. By selecting frequency bands to search for service based on the planned route, the wireless node may acquire service more quickly than the wireless node would otherwise acquire service, enabling the wireless node to save power. The wireless node may also enable other PLMNs to avoid unnecessarily signaling the wireless node, because the wireless node does not attempt to camp on those other PLMNs. By preferentially scanning frequency bands on which the wireless node is expected to find service, the wireless node may also shorten the camping time and improve the user experience by shortening the time the wireless node is out of service.

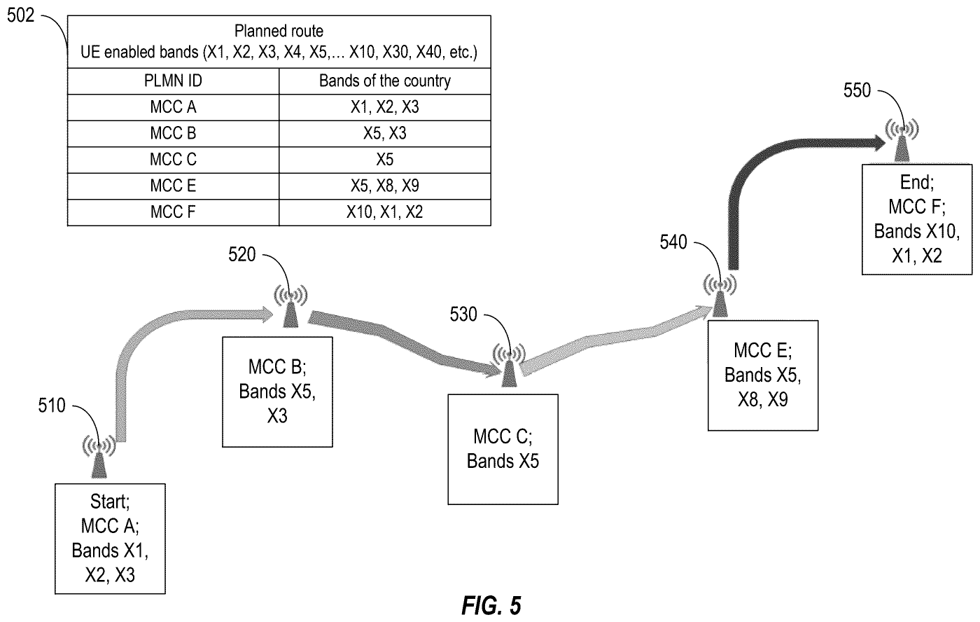

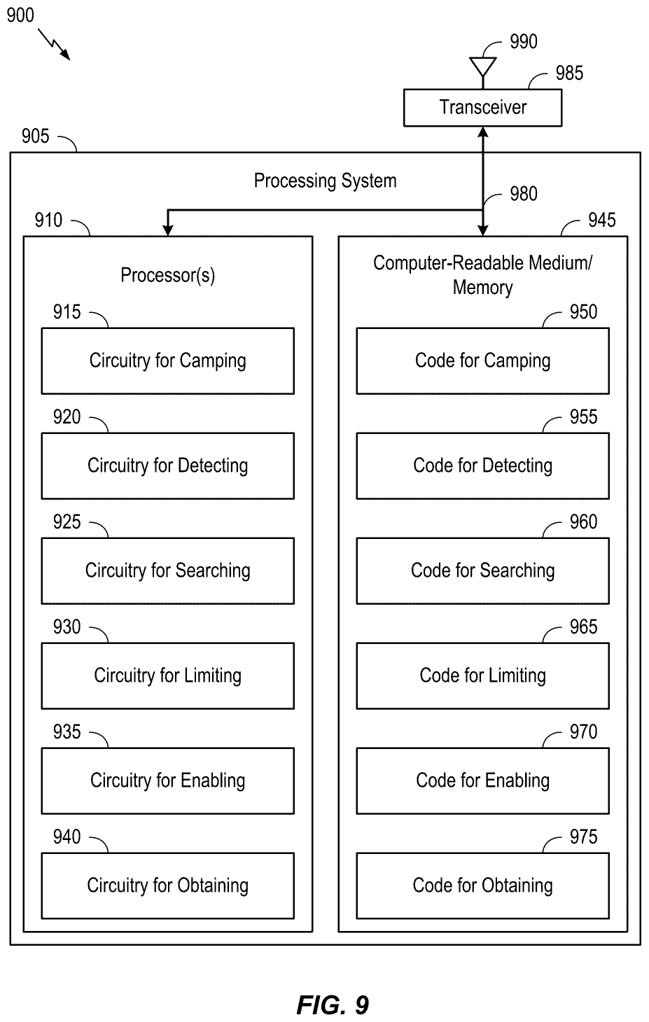

FIG. 5 depicts an example of a planned route for a wireless node (e.g., UE 104, shown in FIGS. 1-3 or communications device 900, shown in FIG. 9), according to aspects of the present disclosure. Table 502 is an example list of PLMN identifiers (IDs) and corresponding frequency bands for the planned route. The information indicated in table 502 can indicate to the wireless node what frequencies the wireless node should select to search for service.

As illustrated at 510, a wireless node following the planned route shown in table 502 begins by camping on one of the frequency bands X1, X2, or X3 associated with MCC A. As the wireless node transits the planned route, as illustrated at 520, the wireless node should next select frequency bands X5 and X3 associated with MCC B to search for service. As shown at 530, the wireless node should then select frequency band X5 associated with MCC C. As shown at 540, the wireless node should then select frequency bands X5, X8, and X9 associated with MCC E. And finally, as illustrated at 550, at the end of the planned route, the wireless node should select frequency bands X10, X1, and X2 associated with MCC F.

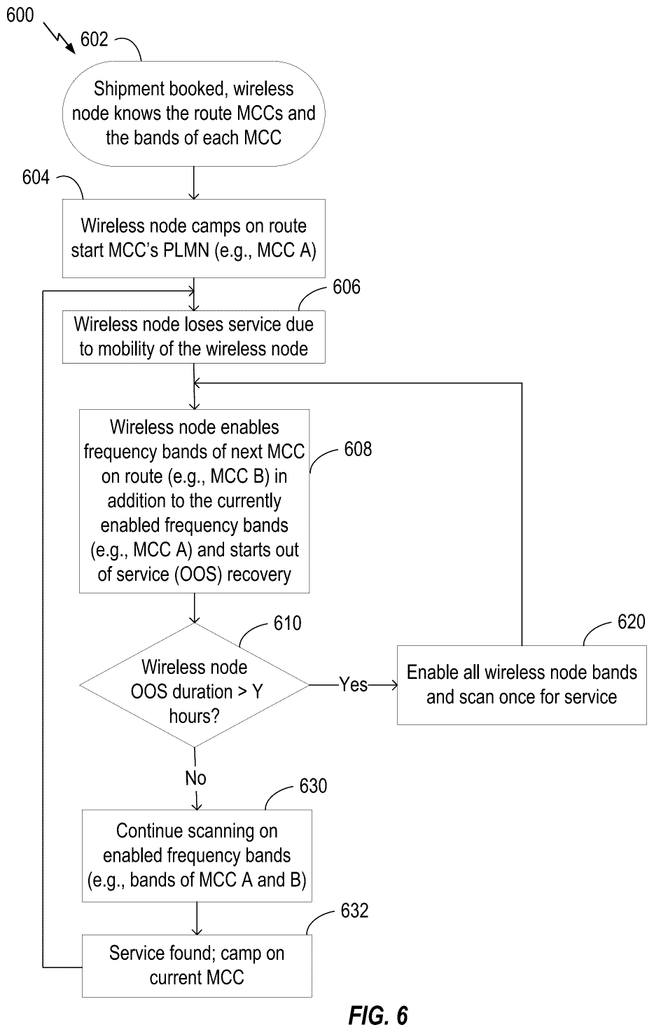

FIG. 6 depicts an example flow chart 600 of operations by a wireless node (e.g., UE 104, shown in FIGS. 1-3 or communications device 900, shown in FIG. 9), according to aspects of the present disclosure. An example of a wireless node operating according to the flow chart 600 is described with reference to FIG. 5. The operations begin at block 602 with a shipment including the wireless node being booked, and the wireless node obtaining route MCCs and frequency bands of each MCC of the planned route for the wireless node.

At block 604, the wireless node camps on a frequency band associated with an MCC associated with the route start. In an example and with reference to FIG. 5, a wireless node operating according to the flow chart 600 camps on one of the frequency bands X1, X2, or X3 associated with MCC A.

At block 606, the wireless node loses service due to mobility of the wireless node, e.g., the wireless node goes out of range of a wireless network associated with MCC A.

At block 608, the wireless node enables (e.g., tunes a receiver or activates a receive chain) frequency bands of a next MCC on the planned route, in addition to the currently enabled frequency bands, and starts out of service (OOS) recovery on the enabled frequency bands. The OOS recovery includes searching for service on the enabled frequency bands. In the example and with reference to FIG. 5, the wireless node enables frequency band X5, associated with MCC B, in addition to the frequency bands X1, X2, and X3 associated with MCC A, and the wireless node searches for service on the frequency bands X5, X1, X2, and X3.

At block 610, the wireless node determines whether the duration the wireless node has been OOS is longer than a threshold period (e.g., Y hours). If the wireless node has been out of service for longer than the threshold period, then the wireless node proceeds to block 620. If the wireless node has been out of service for less than or equal to the threshold period, then the wireless node proceeds to block 630.

At block 620, the wireless node enables all wireless node bands and scans once for service. In the example and with reference to FIG. 5, the wireless node scans once for service on frequency bands X1, X2, X3, X4, X5, . . . . X10, X30, X40, etc. From block 620, the wireless node returns to block 608. In the example and with reference to FIG. 5, the wireless node finds service on frequency band X5, associated with MCC C.

Upon returning to block 608 from block 620, if the wireless node found service in block 620, then the wireless node enables the frequency bands associated with the MCC found in block 620 and frequency bands associated with a next MCC on the planned route. In the example and with reference to FIG. 5, the wireless device enables frequency band X5, associated with MCC C, and frequency bands X8 and X9, associated with MCC E. The wireless node then proceeds to block 610. Because the wireless node found service in block 620, the wireless node OOS duration is less than the threshold period, and the wireless node proceeds from block 610 to block 630.

If the wireless node did not find service in block 620, then upon returning to block 608 from block 620, the wireless node enables the frequency bands associated with the MCC in which the wireless node last camped in block 604 or block 632 and the frequency bands associated with the next MCC of the planned route. The wireless node then starts an OOS recovery on the enabled frequency bands.

At block 630, the wireless node continues scanning on enabled frequency bands. If the wireless node finds service on the enabled frequency bands, then the wireless node proceeds to block 632. If the wireless node does not find service, then the wireless node will return to block 610 and check whether the wireless node has been OOS for longer than the threshold period.

At block 632, the wireless node camps on a frequency band associated with an MCC at the current location of the UE, i.e., a current MCC. The wireless node camps on the current MCC until the wireless node loses service. The wireless node then proceeds from block 606.

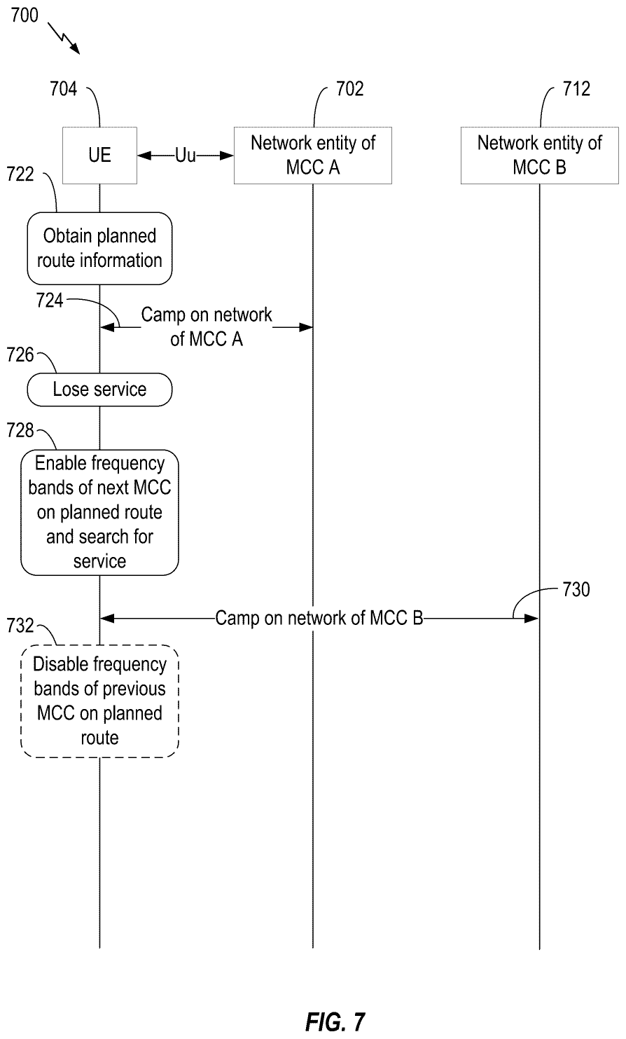

FIG. 7 depicts a call flow diagram 700 for communications in a network between a network entity 702 of MCC A, a user equipment (UE) 704, and a network entity 712 of MCC B.

In some aspects, the network entities 702 and 712 may be examples of the BS 102 depicted and described with respect to FIGS. 1 and 3 or disaggregated base stations depicted and described with respect to FIG. 2. Similarly, the UE 704 may be an example of UE 104 depicted and described with respect to FIGS. 1 and 3. However, in other aspects, UE 704 may be another type of wireless communications device and network entities 702 and 712 may be other types of network entities or network nodes, such as those described herein.

At 722, the UE obtains planned route information. The planned route information may be, for example, a list of MCCs and/or frequency bands the UE may camp on while transiting the planned route, as illustrated in FIG. 5.

At 724, the UE communicates with network entity 702 to camp on the wireless network of MCC A, which is the MCC listed first on the planned route shown in the table 502 on FIG. 5. The wireless network of MCC A may be served by the network entity 702.

At 726, the UE loses (e.g., goes out of) service on the wireless network of MCC A. The UE may, for example, move from location 510 to location 520, as illustrated in FIG. 5. The UE may, for example, move from one country into another country.

At 728, the UE enables frequency bands of a next MCC on the planned route and then searches for service on those frequency bands. For example, the UE may enable frequency bands X5 and X3, associated with MCC B, as shown in the table 502 on FIG. 5.

At 730, the UE camps on the wireless network of MCC B, which is the MCC listed next on the planned route shown in the table 502. The wireless network of MCC B may be served by the network entity 712.

At 732, the UE optionally disables frequency bands of MCC A, which is the MCC preceding the MCC of the network on which the UE is camped.

### Example Operations

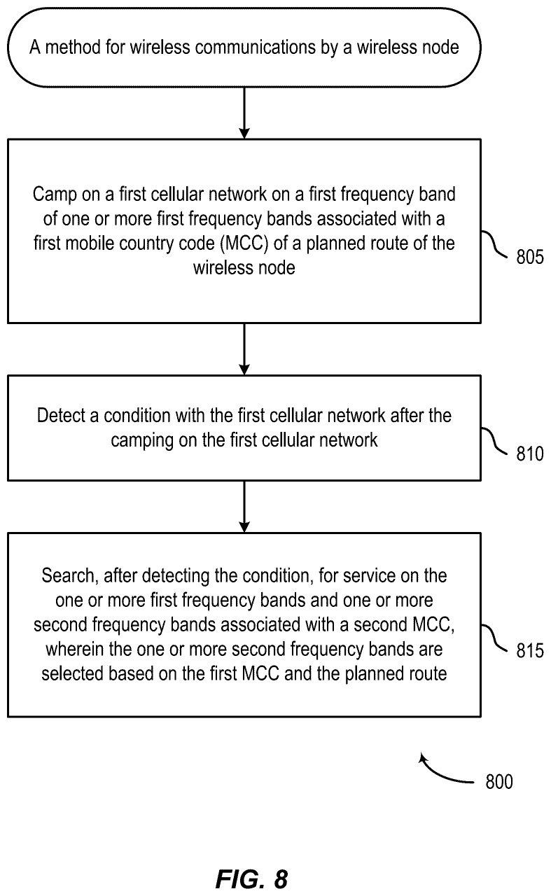

FIG. 8 shows an example of a method 800 of wireless communications by a wireless node, such as a UE 104 of FIGS. 1 and 3.

Method 800 begins at step 805 with camping on a first cellular network on a first frequency band of one or more first frequency bands associated with a first mobile country code (MCC) of a planned route of the wireless node. In some cases, the operations of this step refer to, or may be performed by, circuitry for camping and/or code for camping as described with reference to FIG. 9.

Method 800 then proceeds to step 810 with detecting a condition with the first cellular network after the camping on the first cellular network. In some cases, the operations of this step refer to, or may be performed by, circuitry for detecting and/or code for detecting as described with reference to FIG. 9.

Method 800 then proceeds to step 815 with searching, after detecting the condition, for service on the one or more first frequency bands and one or more second frequency bands associated with a second MCC, wherein the one or more second frequency bands are selected based on the first MCC and the planned route. In some cases, the operations of this step refer to, or may be performed by, circuitry for searching and/or code for searching as described with reference to FIG. 9.

In some aspects, the condition comprises the wireless node being out of service (OOS).

In some aspects, the method 800 further includes limiting the searching for service to the one or more first and the one or more second frequency bands for a period of time after detecting the condition. In some cases, the operations of this step refer to, or may be performed by, circuitry for limiting and/or code for limiting as described with reference to FIG. 9.

In some aspects, the method 800 further includes searching for service on one or more third frequency bands associated with a third MCC after the searching for service on the one or more first frequency bands and the one or more second frequency bands. In some cases, the operations of this step refer to, or may be performed by, circuitry for searching and/or code for searching as described with reference to FIG. 9.

In some aspects, the method 800 further includes camping, after the searching, on a third cellular network on one of the third frequency bands. In some cases, the operations of this step refer to, or may be performed by, circuitry for camping and/or code for camping as described with reference to FIG. 9.

In some aspects, the method 800 further includes detecting another condition with the third cellular network after the camping on the third cellular network. In some cases, the operations of this step refer to, or may be performed by, circuitry for detecting and/or code for detecting as described with reference to FIG. 9.

In some aspects, the method 800 further includes searching, after detecting the other condition, for service on the one or more third frequency bands and one or more fourth frequency bands associated with a fourth MCC, based on the third MCC and the planned route. In some cases, the operations of this step refer to, or may be performed by, circuitry for searching and/or code for searching as described with reference to FIG. 9.

In some aspects, the method 800 further includes enabling, after detecting the condition, the one or more first frequency bands and the one or more second frequency bands in at least one of a transmitter, receiver, or transceiver of the UE. In some cases, the operations of this step refer to, or may be performed by, circuitry for enabling and/or code for enabling as described with reference to FIG. 9.

In some aspects, the method 800 further includes camping, after the searching, on a second cellular network on one of the second frequency bands. In some cases, the operations of this step refer to, or may be performed by, circuitry for camping and/or code for camping as described with reference to FIG. 9.

In some aspects, the method 800 further includes detecting another condition with the second cellular network after the camping on the second cellular network. In some cases, the operations of this step refer to, or may be performed by, circuitry for detecting and/or code for detecting as described with reference to FIG. 9.

In some aspects, the method 800 further includes searching, after detecting the other condition, for service on the one or more second frequency bands and one or more third frequency bands associated with a third MCC, based on the second MCC and the planned route. In some cases, the operations of this step refer to, or may be performed by, circuitry for searching and/or code for searching as described with reference to FIG. 9.

In some aspects, the method 800 further includes obtaining an indication of the planned route before the camping on the first cellular network. In some cases, the operations of this step refer to, or may be performed by, circuitry for obtaining and/or code for obtaining as described with reference to FIG. 9.

In one aspect, method 800, or any aspect related to it, may be performed by an apparatus, such as communications device 900 of FIG. 9, which includes various components operable, configured, or adapted to perform the method 800. Communications device 900 is described below in further detail.

Note that FIG. 8 is just one example of a method, and other methods including fewer, additional, or alternative steps are possible consistent with this disclosure.

### Example Communications Device(s)

FIG. 9 depicts aspects of an example communications device 900. In some aspects, communications device 900 is a user equipment, such as UE 104 described above with respect to FIGS. 1 and 3.

The communications device 900 includes a processing system 905 coupled to the transceiver 985 (e.g., a transmitter and/or a receiver). The transceiver 985 is configured to transmit and receive signals for the communications device 900 via the antenna 990, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 945 via a bus 980. In certain aspects, the computer-readable medium/memory 945 is configured to store instructions (e.g., computer-executable code) that when executed by the one or more processors 910, cause the one or more processors 910 to perform the method 800 described with respect to FIG. 8, or any aspect related to it. Note that reference to a processor performing a function of communications device 900 may include one or more processors 910 performing that function of communications device 900.

In the depicted example, computer-readable medium/memory 945 stores code (e.g., executable instructions), such as code for camping 950, code for detecting 955, code for searching 960, code for limiting 965, code for enabling 970, and code for obtaining 975. Processing of the code for camping 950, code for detecting 955, code for searching 960, code for limiting 965, code for enabling 970, and code for obtaining 975 may cause the communications device 900 to perform the method 800 described with respect to FIG. 8, or any aspect related to it.

The one or more processors 910 include circuitry configured to implement (e.g., execute) the code stored in the computer-readable medium/memory 945, including circuitry such as circuitry for camping 915, circuitry for detecting 920, circuitry for searching 925, circuitry for limiting 930, circuitry for enabling 935, and circuitry for obtaining 940. Processing with circuitry for camping 915, circuitry for detecting 920, circuitry for searching 925, circuitry for limiting 930, circuitry for enabling 935, and circuitry for obtaining 940 may cause the communications device 900 to perform the method 800 described with respect to FIG. 8, or any aspect related to it.

Various components of the communications device 900 may provide means for performing the method 800 described with respect to FIG. 8, or any aspect related to it. For example, means for transmitting, sending, or outputting for transmission may include transceivers 354 and/or antenna(s) 352 of the UE 104 illustrated in FIG. 3 and/or the transceiver 985 and the antenna 990 of the communications device 900 in FIG. 9. Means for receiving or obtaining may include transceivers 354 and/or antenna(s) 352 of the UE 104 illustrated in FIG. 3 and/or the transceiver 985 and the antenna 990 of the communications device 900 in FIG. 9.

### Example Clauses

Implementation examples are described in the following numbered clauses:

Clause 1: A method for wireless communications by a wireless node, comprising: camping on a first cellular network on a first frequency band of one or more first frequency bands associated with a first mobile country code (MCC) of a planned route of the wireless node; detecting a condition with the first cellular network after the camping on the first cellular network; and searching, after detecting the condition, for service on the one or more first frequency bands and one or more second frequency bands associated with a second MCC, wherein the one or more second frequency bands are selected based on the first MCC and the planned route.

Clause 2: The method of Clause 1, wherein the condition comprises the wireless node being out of service (OOS).

Clause 3: The method of any one of Clauses 1-2, further comprising: limiting the searching for service to the one or more first and the one or more second frequency bands for a period of time after detecting the condition.

Clause 4: The method of any one of Clauses 1-3, further comprising: searching for service on one or more third frequency bands associated with a third MCC after the searching for service on the one or more first frequency bands and the one or more second frequency bands.

Clause 5: The method of Clause 4, further comprising: camping, after the searching, on a third cellular network on one of the third frequency bands; detecting another condition with the third cellular network after the camping on the third cellular network; and searching, after detecting the other condition, for service on the one or more third frequency bands and one or more fourth frequency bands associated with a fourth MCC, based on the third MCC and the planned route.

Clause 6: The method of any one of Clauses 1-5, further comprising: enabling, after detecting the condition, the one or more first frequency bands and the one or more second frequency bands in at least one of a transmitter, receiver, or transceiver of the UE.

Clause 7: The method of any one of Clauses 1-6, further comprising: camping, after the searching, on a second cellular network on one of the second frequency bands; detecting another condition with the second cellular network after the camping on the second cellular network; and searching, after detecting the other condition, for service on the one or more second frequency bands and one or more third frequency bands associated with a third MCC, based on the second MCC and the planned route.

Clause 8: The method of any one of Clauses 1-7, further comprising: obtaining an indication of the planned route before the camping on the first cellular network.

Clause 9: An apparatus, comprising: a memory comprising executable instructions; and a processor configured to execute the executable instructions and cause the apparatus to perform a method in accordance with any one of Clauses 1-8.

Clause 10: An apparatus, comprising means for performing a method in accordance with any one of Clauses 1-8.

Clause 11: A non-transitory computer-readable medium comprising executable instructions that, when executed by a processor of an apparatus, cause the apparatus to perform a method in accordance with any one of Clauses 1-8.

Clause 12: A computer program product embodied on a computer-readable storage medium comprising code for performing a method in accordance with any one of Clauses 1-8.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a wireless node, comprising:
camping on a first cellular network on a first frequency band of one or more first frequency bands associated with a first mobile country code (MCC) of a planned route of the wireless node;
detecting a condition with the first cellular network after the camping on the first cellular network; and
searching, after detecting the condition, for service on the one or more first frequency bands and one or more second frequency bands associated with a second MCC, wherein the one or more second frequency bands are selected based on the first MCC and the planned route.

2. The method of claim 1, wherein the condition comprises the wireless node being out of service (OOS).

3. The method of claim 1, further comprising:
limiting the searching for service to the one or more first and the one or more second frequency bands for a period of time after detecting the condition.

4. The method of claim 1, further comprising:
searching for service on one or more third frequency bands associated with a third MCC after the searching for service on the one or more first frequency bands and the one or more second frequency bands.

5. The method of claim 4, further comprising:
camping, after the searching, on a third cellular network on one of the third frequency bands;
detecting another condition with the third cellular network after the camping on the third cellular network; and
searching, after detecting the other condition, for service on the one or more third frequency bands and one or more fourth frequency bands associated with a fourth MCC, based on the third MCC and the planned route.

6. The method of claim 1, further comprising:
enabling, after detecting the condition, the one or more first frequency bands and the one or more second frequency bands in at least one of a transmitter, receiver, or transceiver of the wireless node.

7. The method of claim 1, further comprising:
camping, after the searching, on a second cellular network on one of the second frequency bands;
detecting another condition with the second cellular network after the camping on the second cellular network; and
searching, after detecting the other condition, for service on the one or more second frequency bands and one or more third frequency bands associated with a third MCC, based on the second MCC and the planned route.

8. The method of claim 1, further comprising:
obtaining an indication of the planned route before the camping on the first cellular network.

9. A wireless node configured for wireless communications, comprising:
a memory comprising computer-executable instructions; and
a processor configured to execute the computer-executable instructions and cause the wireless node to:
camp on a first cellular network on a first frequency band of one or more first frequency bands associated with a first mobile country code (MCC) of a planned route of the wireless node;
detect a condition with the first cellular network after the wireless node camps on the first cellular network;
select one or more second frequency bands associated with a second MCC, based on the first MCC and the planned route; and
search, after the wireless node detects the condition, for service on the one or more first frequency bands and the one or more second frequency bands.

10. The wireless node of claim 9, wherein the condition comprises the wireless node being out of service (OOS).

11. The wireless node of claim 9, wherein the processor is configured to execute the computer-executable instructions and further cause the wireless node to:
limit a search for service to the one or more first and the one or more second frequency bands for a period of time after detecting the condition.

12. The wireless node of claim 9, wherein the processor is configured to execute the computer-executable instructions and further cause the wireless node to:
search for service on one or more third frequency bands associated with a third MCC after the wireless node searches for service on the one or more first frequency bands and the one or more second frequency bands.

13. The wireless node of claim 12, wherein the processor is configured to execute the computer-executable instructions and further cause the wireless node to:
camp, after the wireless node searches for service on the one or more third frequency bands, on a third cellular network on one of the third frequency bands;
detect another condition with the third cellular network after the wireless node camps on the third cellular network;
select one or more fourth frequency bands associated with a fourth MCC, based on the third MCC and the planned route; and
search, after the wireless node detects the other condition, for service on the one or more third frequency bands and the one or more fourth frequency bands.

14. The wireless node of claim 9, wherein the processor is configured to execute the computer-executable instructions and further cause the wireless node to:
enable, after the wireless node detects the condition, the one or more first frequency bands and the one or more second frequency bands in at least one of a transmitter, receiver, or transceiver of the wireless node.

15. The wireless node of claim 9, wherein the processor is configured to execute the computer-executable instructions and further cause the wireless node to:
camp, after the wireless node searches for service on the one or more first frequency bands and the one or more second frequency bands, on a second cellular network on one of the second frequency bands;
detect another condition with the second cellular network after the wireless node camps on the second cellular network;
select one or more third frequency bands associated with a third MCC, based on the second MCC and the planned route; and
search, after the wireless node detects the other condition, for service on the one or more second frequency bands and the one or more third frequency bands.

16. The wireless node of claim 9, wherein the processor is configured to execute the computer-executable instructions and further cause the wireless node to:
obtain an indication of the planned route before the wireless node camps on the first cellular network.

17. An apparatus for wireless communications, comprising:
means for camping on a first cellular network on a first frequency band of one or more first frequency bands associated with a first mobile country code (MCC) of a planned route of the apparatus;
means for detecting a condition with the first cellular network after camping on the first cellular network; and
means for searching, after detecting the condition, for service on the one or more first frequency bands and one or more second frequency bands associated with a second MCC, wherein the one or more second frequency bands are selected based on the first MCC and the planned route.

18. The apparatus of claim 17, wherein the condition comprises the apparatus being out of service (OOS).

19. The apparatus of claim 17, further comprising:
means for limiting a search for service to the one or more first and the one or more second frequency bands for a period of time after detecting the condition.

20. The apparatus of claim 17, further comprising:
means for searching for service on one or more third frequency bands associated with a third MCC after a search for service on the one or more first frequency bands and the one or more second frequency bands.

21. The apparatus of claim 20, further comprising:
means for camping, after a search for service on the one or more third frequency bands, on a third cellular network on one of the third frequency bands;
means for detecting another condition with the third cellular network after camping on the third cellular network; and
means for searching, after detecting the other condition, for service on the one or more third frequency bands and one or more fourth frequency bands associated with a fourth MCC, based on the third MCC and the planned route.

22. The apparatus of claim 17, further comprising:
means for enabling, after detecting the condition, the one or more first frequency bands and the one or more second frequency bands in at least one of a transmitter, receiver, or transceiver of the apparatus.

23. The apparatus of claim 17, further comprising:
means for camping, after a search for service on the one or more second frequency bands, on a second cellular network on one of the second frequency bands;
means for detecting another condition with the second cellular network after camping on the second cellular network; and
means for searching, after detecting the other condition, for service on the one or more second frequency bands and one or more third frequency bands associated with a third MCC, based on the second MCC and the planned route.

24. The apparatus of claim 17, further comprising:
means for obtaining an indication of the planned route before camping on the first cellular network.

25. A non-transitory computer-readable medium comprising computer-executable instructions that, when executed by a processor of a wireless node, cause the wireless node to perform operations for wireless communications, comprising:
camping on a first cellular network on a first frequency band of one or more first frequency bands associated with a first mobile country code (MCC) of a planned route of the wireless node;
detecting a condition with the first cellular network after the camping on the first cellular network; and
searching, after detecting the condition, for service on the one or more first frequency bands and one or more second frequency bands associated with a second MCC, wherein the one or more second frequency bands are selected based on the first MCC and the planned route.

26. The computer-readable medium of claim 25, wherein the condition comprises the wireless node being out of service (OOS).

27. The computer-readable medium of claim 25, wherein the operations further comprise:
limiting the searching for service to the one or more first and the one or more second frequency bands for a period of time after detecting the condition.

28. The computer-readable medium of claim 25, wherein the operations further comprise:
searching for service on one or more third frequency bands associated with a third MCC after the searching for service on the one or more first frequency bands and the one or more second frequency bands.

29. The computer-readable medium of claim 25, wherein the operations further comprise:
enabling, after detecting the condition, the one or more first frequency bands and the one or more second frequency bands in at least one of a transmitter, receiver, or transceiver of the wireless node.

30. The computer-readable medium of claim 25, wherein the operations further comprise:
camping, after the searching, on a second cellular network on one of the second frequency bands;
detecting another condition with the second cellular network after the camping on the second cellular network; and
searching, after detecting the other condition, for service on the one or more second frequency bands and one or more third frequency bands associated with a third MCC, based on the second MCC and the planned route.
